(19) United States
(12) Patent Application Publication
(10) Pub. No.: US 2012/0138154 A1
(43) Pub. Date: Jun. 7, 2012

(54) MICROFLUIDIC DEVICE FOR CONVEYING A SUBSTANCE BY DIFFUSION IN A POROUS SUBSTRATE

(75) Inventors: David Grosso, Cheptainville (FR); Mika Linden, Turku (FI); Clement Sanchez, Bure Sur Yvette (FR)

(73) Assignee: UNIVERSITE PIERRE ET MARIE CURIE (PARIS 6), Paris (FR)

(21) Appl. No.: 13/376,771

(22) PCT Filed: Aug. 6, 2010
(86) PCT No.: PCT/EP2010/058037

§ 371 Date: Feb. 21, 2012

(30) Foreign Application Priority Data
Jun. 8, 2009 (FR) 09 02753

(51) Int. Cl. F17D 3/00; F16L 55/027

(52) U.S. Cl. 137/1; 138/40

(57) ABSTRACT

The invention provides a microfluidic device for conveying substance by diffusion in a porous substrate from a substance injection zone to a substance arrival zone, which zones are connected by a substance-channeling zone. According to the invention, the porous substrate presents a free surface that is partially covered by a mask that is impermeable and that extends from the injection zone to the arrival zone in order to define the substance-channeling zone in the substrate so as to enable the substance to evaporate through a non-covered portion of the free surface.

The invention relates to a so-called “micro” or “nano”-fluidic device for moving very small quantities of substance by diffusion through a porous matrix.

### BACKGROUND OF THE INVENTION

Moving a fluid proper or a solute dissolved in a fluid (referred to below as substances) by diffusion through a porous substrate is involved in a variety of applications, such as separation (membranes, molecular sieves), heterogeneous catalysis (catalyst support), analysis (environment sensors, chromatography, medical analyses).

It is known to shape such a porous matrix in the form of a cylindrical microduct for feeding at one of its ends with substance and that is sheathed by a covering of material that is impermeable to the substance that is to be conveyed. The covering thus confines the flow of substance within the duct from one of its ends to the other, which flow may be driven either by natural forces (capillarity) or by external drive (such as a pressure difference, an electric field).

Patent application US 2007/0092411 discloses a microfluidic duct having a first substrate with walls that define a flow channel, which channel is filled with porous substrate and is covered by a second substrate.

Either way those configurations suffer from drawbacks. In particular fabricating sheathed microducts or substrates defining channels is quite difficult.

Document FR 2 282 469 discloses a microfluidic device having a porous substrate in the form of a layer with a first face bearing against an impermeable support and an opposite face forming a free surface thorough which the substance being transported is capable of evaporating. Orifices in the support define a substance injection zone and a substance arrival zone in the substrate, which zones open out into the face that is in contact with the support.

Document U.S. Pat. No. 5,223,220 describes a device having a porous substrate in the form of a layer enclosed in a box having a bottom that forms an impermeable support and a lid that covers the porous substrate, while leaving portions of the facing surface of the porous substrate uncovered in order to define substance injection and arrival zones therein.

In that type of device, the substance injected into the injection zone diffuses into the porous substrate but does not have any possibility of evaporating before it reaches the arrival zone.

### OBJECT OF THE INVENTION

The object of the present invention is to remedy the drawbacks of the above-mentioned devices and that makes it possible in particular to fabricate and/or use such devices in simpler manner.

### BRIEF SUMMARY OF THE INVENTION

The invention provides a microfluidic device for conveying a substance by diffusion in a porous substrate from a substance injection zone to a substance arrival zone, which zones are interconnected by a substance-channeling zone, the porous substrate being in the form of a layer having one face extending against a support that is impermeable to the substance and an opposite face forming a free surface into which the injection zone opens out, the device being characterized in that the free surface is covered in part by a mask that is impermeable to the substance and that extends from the injection zone to the arrival zone in order to define the substance-channeling zone in a portion of the substrate that is covered by the mask, by enabling the substance to diffuse in the substrate under the mask from the injection zone to the arrival zone simultaneously with the substance evaporating via the non-covered portions of the free surface on either side of the mask.

The substance introduced into the injection zone is thus subjected to competition between diffusing into the porous substrate under the mask and evaporating laterally via the non-covered free surface portion. By ensuring that the diffusion rate is faster than the evaporation rate, it is possible to cause the substance to be transported under the mask, which thus defines a substance-channeling zone in the substrate, even though no boundary or wall defines this substance-channeling zone laterally. Thus, instead of avoiding evaporation, the device of the invention takes advantage of that phenomenon for channeling the substance under the mask.

This makes it easy to confer a very wide variety of shapes and lengths on the substance-channeling zone of the device of the invention, solely by adapting the shape and the length of the mask.

It can be understood that in the ambit of the present invention the substance is:

either in the form of a liquid that may be conveyed in accordance with the invention in a pure form or as diluted in a suitable solvent;

or else in the form of solid, e.g. a powder, that is dissolved in a suitable solvent.

It can also be understood that the substance is a mixture of a plurality of substances.

### BRIEF DESCRIPTION OF THE DRAWINGS

Other characteristics and advantages of the invention appear more clearly in the light of the following description and the accompanying drawings, showing various particular and non-limiting embodiments of the invention.

Reference is made to the figures of the accompanying drawings, in which:

FIG. 1 is a perspective view of a microfluidic device of the invention;

FIG. 2 is cross-section view of the FIG. 1 device on plane P2; FIG. 1a is a longitudinal section view of the device of FIG. 1 on plane P1; and

FIGS. 3a, 3b, 3c, 3d, and 3e are longitudinal section views of a portion of the substance-channeling zone in the porous substrate in different variants of the invention.

The figures are deliberately highly diagrammatic and they are not to scale between the various components shown in order to make them easier to read, each of the elements shown conserving the same references in all of the figures.

### DETAILED DESCRIPTION OF THE FIGURES

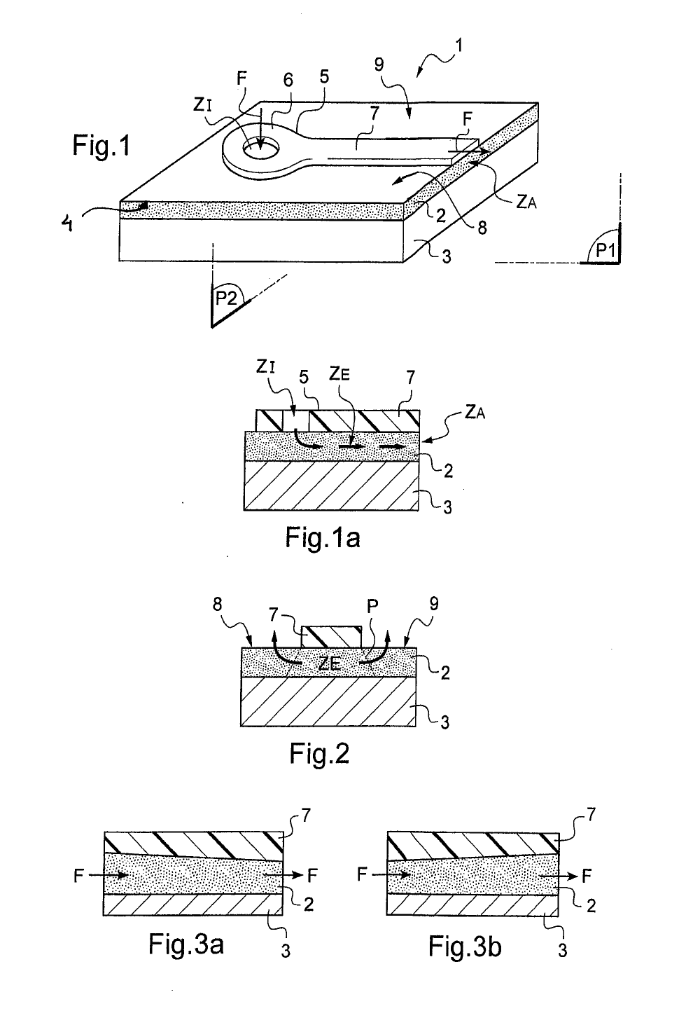

FIG. 1 thus shows a microfluidic device 1 of the invention for transporting a given substance F in a porous substrate. The term “microfluidic” is used to mean that the device is suitable for transporting very small quantities of substance (this term likewise including so-called “nanofluidic” devices). The device 1 comprises a porous substrate in the form of a layer 2 fitted onto a support 3 that is impermeable to the substance in question. In this embodiment, the support 3 is plane, and the layer 2 presents a free surface 4 opposite from its face in contact with the support 3, which surface is likewise substantially plane. The layer 2 presents an injection zone ZI for injecting the substance F close to one of its edges, and a substance arrival and collection zone ZA close to the edge opposite from the above-mentioned edge, with the flow direction of the substance F from one of the injection and arrival zones ZI and ZA to the other in the layer 2 being symbolized by straight arrows.

In this example, the porous substrate of the layer 2 is made of silicon oxide SiO₂ having open pores with a diameter of 15 nanometers (nm) on average. Its porosity is about 60%. The layer 2 has a thickness of about 300 nm. It is deposited on the support 3 by techniques that are known in the field of thin-film deposition, e.g. in this example using a sol-gel technique based on known precursors.

The layer 2 is surmounted by a mask 5, which in this example is an impermeable polydimethyl siloxane (PDMS) membrane that covers part of the layer 2. This mask is selected to be impermeable to the substance F that is to be conveyed by the device of the invention.

As an illustration, the reference substance F in this example is an aqueous solution of SnCl₄.

In an upstream region 6 (relative to the substance flow direction), the mask shown forms a ring with a central orifice defining the injection zone ZI into the porous substrate and onto which the substance for transporting is deposited by means of a pipette or a syringe. In a downstream zone, the mask is in the form of a strip 7 leaving free two portions 8, 9 of the free surface 4 of the layer 2 on either side of the strip 7.

FIGS. 1a and 2, in combination with FIG. 1, make it easier to understand how the strip 7 of the mask 5 serves to define the substance-channeling zone ZE for channeling the substance F from the injection zone ZI to the arrival zone ZA: the substance F that is injected into the injection zone ZI flows under the upstream region 6 of the mask 5 since it is prevented from evaporating by the presence of the mask. As soon as the substance F goes beyond the upstream region 6 of the mask 5, it can evaporate through the zones 8 and 9 that have been left free of the layer 2, as represented in FIG. 2 in the form of small curved arrows, whereas in the zone of the layer 2 that is covered by the downstream portion 7 of the mask 5, the substance diffuses in the layer 2 towards the arrival zone ZA.

As shown in FIG. 2, which is a cross-section view of the device through the downstream region of the mask 5, the edges of the strip 7 of the mask 5 thus define in the layer 2 the substance-channeling zone ZE that extends essentially under the mask.

In the thickness of the layer 2, the substance-channeling zone ZE has a profile P that flares from the surface of the layer 2 in contact with the strip 7 of the mask 5 towards the surface of the layer 2 in contact with its support 3. This profile is shown diagrammatically. Depending on the type of substance and on the characteristics of the porous substrate it may be different, in particular it may flare to a greater or lesser extent. Highly diagrammatic FIG. 2 shows outlines that are linear and very sharp for this profile P. It should be understood that in reality the profile is defined rather by outlines that are curved and furthermore that are not as sharp, the interface between the substance in liquid form in the zone ZE and the substance changing to gaseous form outside said zone, itself being diffuse.

The arrangement of the mask 5 on the layer 2 thus confines the substance F in a substance-channeling zone ZE having lateral boundaries that are predetermined.

In a second example, the porous substrate constituting the layer 2 is made of silicon oxide SiO₂ having open pores with a mean diameter of 200 nm and a porosity of about 30%. The layer 2 has a thickness of about 500 nm and, as in the above example, it is deposited by a sol-gel technique. The other components of the device and the mode of operation of the device remain unchanged compared with Example 1.

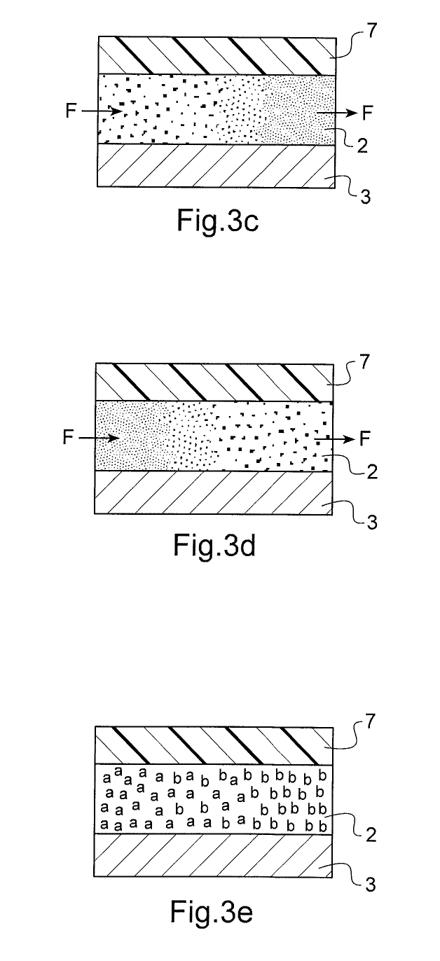

FIGS. 3a to 3e show embodiment variants in which the porous substrate remains in the form of a layer 2 fitted onto a support 3, but presents a physicochemical characteristic that varies in the substance-channeling zone ZE of the layer. This variation may be regular, such as a gradient, or it may equally well be irregular, e.g. in steps, or it may affect only a portion of the substance-channeling zone. In the figures and preferably, this variation affects the substance-channeling zone in the longitudinal direction of the substance-channeling zone, i.e. in the flow direction of the substance.

FIGS. 3a to 3e all show longitudinal sections of the portions of the zone ZE, with arrows recalling the flow direction of the substance. Thus, FIG. 3a shows a longitudinal section of the zone ZE in which the thickness of the layer decreases regularly in the manner of a gradient, and FIG. 3b shows a like section in which, in contrast, the thickness of the layer increases in regular manner. Naturally, it is also possible to provide for variations of thickness in the width of the substance-channeling zone.

FIG. 3c shows another variant in which porosity increases along the zone ZE (shown very symbolically), whereas in FIG. 3d porosity decreases along the zone ZE.

FIG. 3e shows yet another variant in which the chemical composition of the material varies along the zone, comprising (as shown very symbolically once more) a layer that is constituted entirely of one substance a close to the injection zone ZI and that then progressively includes more and more of a second substance b such that, in its portion closest to the arrival zone ZA, it is constituted entirely of the substance b. Naturally, provision may also be made for the entire porous substrate to be constituted using a common mixture of substances ab, with only the relative proportion changing along the substance-channeling zone. It should be observed that provision may also be made to modify the chemical composition of the layer in its thickness or in its cross-section.

In other variants of the invention, this variation may also affect the substance-channeling zone transversely to the flow direction, or indeed in the thickness of the layer in the flow channeling zone.

It should be observed that in the embodiments described above, the substance flows in the layer by capillarity, but that, in known manner, its mode of propagation and in particular its speed may be modified by acting on external factors, such as applying an electric field or a pressure difference.

Naturally, care is taken to select the type of substance and the type of porous substrate appropriately to ensure that the speed of diffusion of the substance under consideration in the porous substrate under consideration remains greater than its speed of evaporation so as to avoid the substance propagating in the portion of the free surface of the porous substrate that is not covered by the mask, and so as to ensure that the substance is properly conveyed from the injection zone ZI to the arrival zone ZA.

Similarly, it is advantageous to modulate the vapor pressure around the device so as to control the evaporation of the substance via the free surface portion that is not covered by the porous substrate.

The invention is not limited to the examples described above, and it covers any variant that remains within the ambit of the claims.

In particular, porous substrates other than those described in the above examples may be used. Preferably, a material is selected that has interconnecting pores with a pore size lying in the range 1 nm to 1000 nm, and in particular in the range 10 nm to 210 nm.

When it is in the form of a layer, its thickness is preferably at least 10 nm, and for example it may lie in the range 10 nm to 50,000 nm. By way of example, it is at most 50 nm or at most 500 nm. It may be deposited on a support in the form of a layer by any type of method for fabricating thin layers directly on a support, e.g. by pyrolysis of precursors that are liquid (including sol-gel deposits), solid, or gaseous, or indeed by vacuum deposition techniques of the optionally reactive cathode sputtering type, possibly assisted by a magnetic field. In particular if it is in the form of a porous polymer, it may also be fabricated in the form of a film that is subsequently secured on a support.

Still in the ambit of the invention, it is possible to devise a substrate that is porous over a certain thickness and impermeable to the substance over the remainder of its thickness: that provides a porous substrate with its support incorporated therein.

As can be seen in Examples 1 and 2, the porous substrate may be of the silicon oxide type. More generally, it may comprise at least one oxide, nitride, or carbide of at least one element M that is preferably selected from silicon Si, or a metal, in particular Al, Ti, Zr, or Ce, or else it may be produced by mixing at least two of those substances. By way of example, it is possible to use mixtures of silicon and/or metal oxycarbide and/or oxynitride. In addition to such porous materials of inorganic type, it is possible for the porous material to include a certain quantity of organic substances that are polymerized to a greater or lesser extent: it is then possible to speak of hybrid or nanocomposite materials.

It is also possible to select porous materials that are made of polymers, e.g. of polymethylmethacrylate (PMMA) or of polystyrene (PS), or indeed of polyethylene (PE), alone or in a mixture, in particular in the form of block copolymers, or indeed as a polymer containing a backbone of substances including Si—O—Si bonds.

Provision may also be made for the porous substrate, regardless of its chemical composition, to be functionalized on its surface by organic groups including at least one carbon atom and at least one coupling agent of complexing type such as a phosphate, or a carboxylic acid, or of silane or siloxane type.

In a variant of the invention, provision may also be made for the porous substrate to include a stack of porous layers having different physicochemical characteristic, such a configuration making it possible in particular to distinguish between the flows of different substances coming from a single substance, each substance presenting a particular affinity for a particular layer of the stack, thereby making it possible, de facto, to have variations in the compositions or the porosities in the thickness of the porous substrate, as mentioned above.

The mask in the above examples is described as having no pores. Alternatively, it may present pores, but they are selected to be of a size that is smaller than the pores of the porous substrate.

The porous substrate is described in the above examples as being in the form of a substantially plane layer deposited on a likewise plane support. Naturally, it is possible to use a support that is not plane, for example that presents a surface on which the layer is deposited that is itself curved, convex, concave, undulating, . . . , with the layer thereby adopting the same profile. Even under such circumstances, the device remains simpler to fabricate than the channels or solid micro-ducts of the prior art.

The porous substrate preferably has porosity of at least 10%, and preferably lying in the range about 30% to about 60%.

The mask is preferably pressed against the free surface of the layer with substantially continuous direct contact between the two materials. Nevertheless, it is also possible to envisage that contact is not perfectly continuous, without substantially affecting the technical technique of the invention, i.e. constraining the substance to flow in the zone underlying the mask, in particular if bubbles of vapor of the substance become trapped at the interface between the layer and the mask.

The mask may then be designed to be removable, which is very advantageous: if it is possible to place it on the porous substrate and also to remove it without significantly affecting the integrity of the layer or the integrity of the mask, it is then possible as a function of the substance that is to be transported, or of the path that is to be made to follow, to design sets of porous layers and sets of masks that can subsequently be associated in pairs depending on requirements. If a layer or a mask presents defects, it can then be replaced without it being necessary to replace the entire unit.

Finally, the device of the invention may be used as means for conveying substances to distinct analysis devices. However it may also be designed so that while the substance is being transported in the porous substrate, the substance is subjected to a modification or to a treatment (such as separating its component substances, as mentioned above with the variant using a stack of layers having different porous substrates). In particular, there may be separation between different substances contained in the original substance, or a heterogeneous catalysis reaction of the substances or of one of the substances contained therein. Under such circumstances, provision may thus be made for the device of the invention also to include appropriate catalysis or treatment means.

The device of the invention may also include an enclosure having a controlled atmosphere in which the porous substrate is placed.

The invention also provides methods of using the device in two alternative variants.

In a first variant, the substance for conveying is injected into the porous substrate while the substrate is dry. The substance is conveyed in liquid form in the porous substrate under the mask by capillarity and it evaporates in the free surface portions of the porous substrate that are not covered, as explained in detail above.

In a second variant utilization, the porous substrate is impregnated with a solvent prior to injecting the substance for conveying therein, which substance is soluble and/or miscible in the solvent in question. As explained in the introduction to the application, the substance may be constituted solely by a pure substance that is to be conveyed, or by a solid or a liquid that has been put into solution in a solvent (the same solvent as is used for impregnating a substrate or some other solvent that is compatible/miscible therewith). Prior impregnation of the porous substrate 15′ may be performed by capillary condensation, by placing the substrate in a solvent-rich atmosphere and then reducing the relative pressure of the solvent after saturating the layer so as to enable evaporation. It is then necessary to wait for evaporation to leave solvent remaining only in the injection zone, the channeling zone, and the arrival zone. Once injected into the porous substrate, the substance, whether pure or dissolved in a liquid, is conveyed through the substrate under the mask by osmosis or by diffusion at the solid/liquid interface, the solvent initially impregnating the substrate in this substance-channeling zone serving as a kind of diffusion medium for the substance or the solution without itself moving: the residual solvent defines liquid channels in which the substances injected into the injected zone can migrate by diffusion in the solvent channels.

1. A microfluidic device for conveying a substance by diffusion in a porous substrate from a substance injection zone to a substance arrival zone, which zones are interconnected by a substance-channeling zone, the porous substrate being in the form of a layer having one face extending against a support that is impermeable to the substance and an opposite face forming a free surface into which the injection zone opens out, wherein the free surface is covered in part by a mask that is impermeable to the substance and that extends from the injection zone to the arrival zone in order to define the substance-channeling zone in a portion of the substrate that is covered by the mask, by enabling the substance to diffuse in the substrate under the mask from the injection zone to the arrival zone simultaneously with the substance evaporating via the non-covered portions of the free surface on either side of the mask.

2. A device according to claim 1, wherein the porous substrate presents interconnected pores, preferably having a pore size lying in the range 1 nanometers to 1000 nanometers.

3. A device according to claim 1, wherein the porous substrate has a thickness of at least 10 nanometers, and preferably lying in the range 10 nanometers to 50,000 nanometers.

4. A device according to claim 1, wherein the porous substrate comprises at least one oxide, nitride, or carbide of at least one element M selected from silicon Si and a metal, in particular Al, Ti, Zr, and Ce, or is the product of mixing at least two of said substances, or indeed of one or more porous (co)polymers.

5. A device according to claim 1, wherein the porous substrate has porosity of at least 10%, preferably lying in the range about 30% to about 60%.

6. A device according to claim 1, wherein the porous substrate is a layer applied to a support and presents at least one physicochemical characteristic that varies in the substance-channeling zone, preferably in the flow direction of the substance, e.g. a variation of thickness, and/or a variation of porosity, and/or a variation of chemical composition.

7. A device according to claim 1, wherein the porous substrate comprises a stack of porous layers having different physicochemical characteristics.

8. A device according to claim 1, wherein the mask does not have pores or presents pores of a size that is smaller than the pores of the porous substrate.

9. A device according to claim 1, wherein the mask comprises at least one polysiloxane.

10. A device according to claim 1, wherein the mask is removable.

11. A device according to claim 1, including means for treating the substance.

12. A method of using the device of claim 1, wherein the substance for conveying is injected into the porous substrate while the substrate is dry.

13. A method of using the device of claim 1, wherein the porous substrate is impregnated with a solvent prior to injecting therein the substance for conveying, which substance is miscible with said solvent.
